(19) United States
(12) Patent Application Publication
(10) Pub. No.: US 2012/0311449 A1
(43) Pub. Date: Dec. 6, 2012

(54) INTERNATIONAL BUSINESS MANAGEMENT SYSTEM

(75) Inventor: Lawrence M. Harding, Annapolis, MD (US)

(73) Assignee: High Street Partners, Inc., Annapolis, MD (US)

(21) Appl. No.: 13/489,933

(22) Filed: Jun. 6, 2012

Related U.S. Application Data
(60) Provisional application No. 61/493,636, filed on Jun. 6, 2011.

(51) Int. Cl. G06F 3/048

(52) U.S. Cl. 715/730

(57) ABSTRACT

A user interface to an application is used to manage a collection of data associated with a plurality of business management functions of a multi-national entity. The user interface includes a set of presentation objects, at least some of the presentation objects being operable to control a presentation of information within the user interface. Responsive to input selecting a first presentation object of the set, a first view of a subset of the collection of data associated with a first of the plurality of business management functions is visually rendered in a first region of the user interface.

### CROSS REFERENCE TO RELATED APPLICATIONS

This application claims priority to U.S. Provisional Application No. 61/493,636, filed Jun. 6, 2011, the contents of which are incorporated herein in their entirety.

### BACKGROUND

Companies have historically faced challenges managing small scale overseas operations, due in part to time zone differences, language differences, and the diversity of local statutory requirements. Headquarters staff is often unfamiliar with local overseas operating details, such as tax identification numbers, business registration numbers, statutory reporting requirements, and local employment law. Furthermore, for each country in which a company establishes operations, country-specific accounting and payroll processes generally need to be developed. The resulting web of point solutions, remote employees, and local providers can be difficult to coordinate and manage from a headquarters location.

Point solutions are available to address individual foreign operating needs. For instance, global accounting systems and human resources information systems (HRIS) targeted at large multinational companies are available. Disparate payroll systems are available on a country-by-country basis.

### BRIEF DESCRIPTION OF DRAWINGS

FIG. 1 is a block diagram of the organization of an international management system.

FIG. 2 shows the Global Overview user interface of the international management system.

FIG. 3 is a block diagram of the architecture of the international management system.

FIG. 4 is a block diagram depicting the management of compliance events by the international management system.

FIG. 5 is a block diagram depicting the management of changes in compliance events by the international management system.

FIG. 6 shows the compliance user interface of the international management system.

### SUMMARY

In a general aspect, a non-transitory computer-readable medium stores executable instructions for causing a processor to visually render on a display device a user interface to an application operable to manage a collection of data associated with a plurality of business management functions of a multi-national entity. The user interface includes a set of presentation objects, at least some of the presentation objects being operable to control a presentation of information within the user interface. The computer-readable medium further stores instructions for causing the processor to, responsive to input selecting a first presentation object of the set, visually render in a first region of the user interface, a first view of a subset of the collection of data associated with a first of the plurality of business management functions.

Embodiments may include one or more of the following.

The computer-readable medium further includes instructions for causing the processor to, responsive to user input selecting a second presentation object of the set, visually render in the first region of the user interface, a second view of the subset of the collection of data associated with the first of the plurality of business management functions.

The computer-readable medium further includes instructions for causing the processor to, responsive to user input selecting a third presentation object of the set, visually render in a second region of the user interface, a first view of the subset of the collection of data associated with a second of the plurality of business management functions.

The business management functions includes at least one of accounting, financial reporting, payroll, expense reporting, cash management, compliance tracking, human resources management, and legal advisory services.

The user interface includes a region associated with social networking

In another general aspect, a non-transitory computer-readable medium stores executable instructions for causing a processor to identify compliance events applicable to a multi-national entity from a compliance event database based on an attribute of the multi-national entity; visually render on a display device a user interface to an application operable to manage the compliance events, the user interface including a representation of at least one of the identified compliance events. The computer-readable medium further stores instructions for causing the processor to, responsive to input associated with a first compliance event of the identified compliance events, perform an action on the first compliance event.

Embodiments may include one or more of the following.

The action includes at least one of modifying the first compliance event, deleting the first compliance event, or performing an action associated with fulfilling the compliance event.

The user interface is further a user interface to an application operable to manage a collection of data associated with a plurality of business management functions of the multi-national entity.

The computer-readable medium further includes instructions for causing the processor to provide, to a user, a notification of at least one of the identified compliance events.

A computer-based international management system provides a platform through which a company (referred to herein as a “customer” of the international management system) is able to manage all of its international operating needs. For instance, through a single user interface, the customer can access and manage administrative domains such as international accounting, payroll, expense reporting, cash management, and human resources management. In addition, the customer can monitor changes in international operating laws relevant to the customer's particular situation. The system also enables the customer to track the status of international compliance filings and provides a single location in which all international documents, such as tax returns, banking statements, financial reports, and employment agreements, can be stored and managed.

A single, interactive, web-based international management system that addresses all aspects of managing an overseas entity facilitates the consolidation of headquarters and overseas operations. The integrated nature of the user interface, through which various administrative domains are accessible, provides visibility into ongoing operations, reduces or eliminates inter-office communications delays, and facilitates functional solutions to administrative challenges that are compatible across administrative domains. The use of the international management system described herein allows a customer to more efficiently manage overseas operation in an automated process with minimal labor demands.

As an example, the international management system described herein offers advantages in international cash management. Information such as holdings, account numbers, and banking statements are consolidated in a single location for all countries rather than being dispersed among various external parties.

In some embodiments, the international management system is targeted to companies with small international operations (e.g., less than 50 employees per country), such as startup companies funded by venture capital or universities with small overseas offices. Companies of this size generally do not have the financial resources to hire an accountant, a human resources specialist, or other domain-specific administrator in each country. Instead, all domains of the international presence of such small companies are generally managed remotely (e.g., from the headquarters site) by a single department or even a single person. In many cases, this person or department does not have significant technical expertise in each domain and is not intimately familiar with business-related rules and requirements in each country. The use of an integrated international management system in which all domains and all countries of operation are represented in a single interface thus offers advantages for small companies lacking the size, financial resources, or personnel structure to adequately oversee complex international operations.

### 1 System Architecture

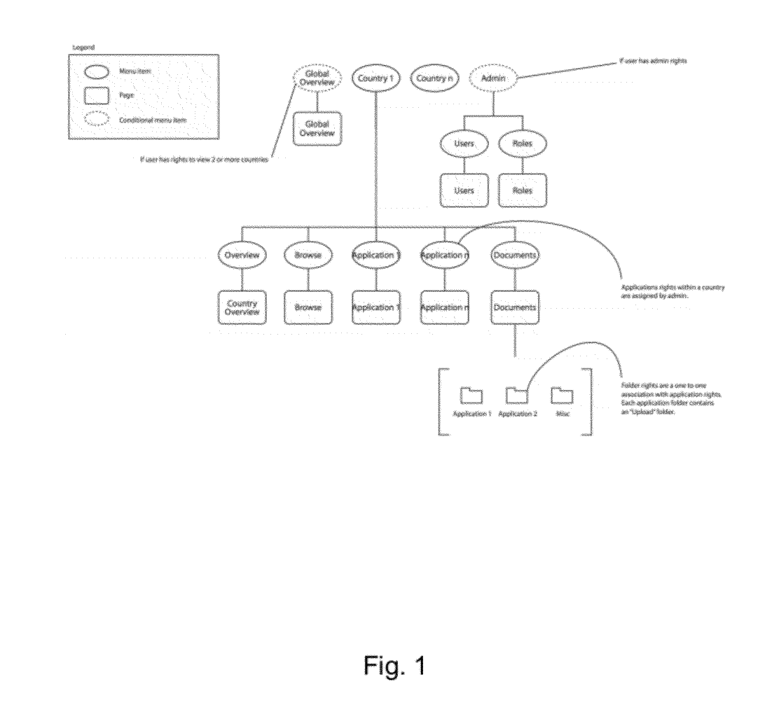

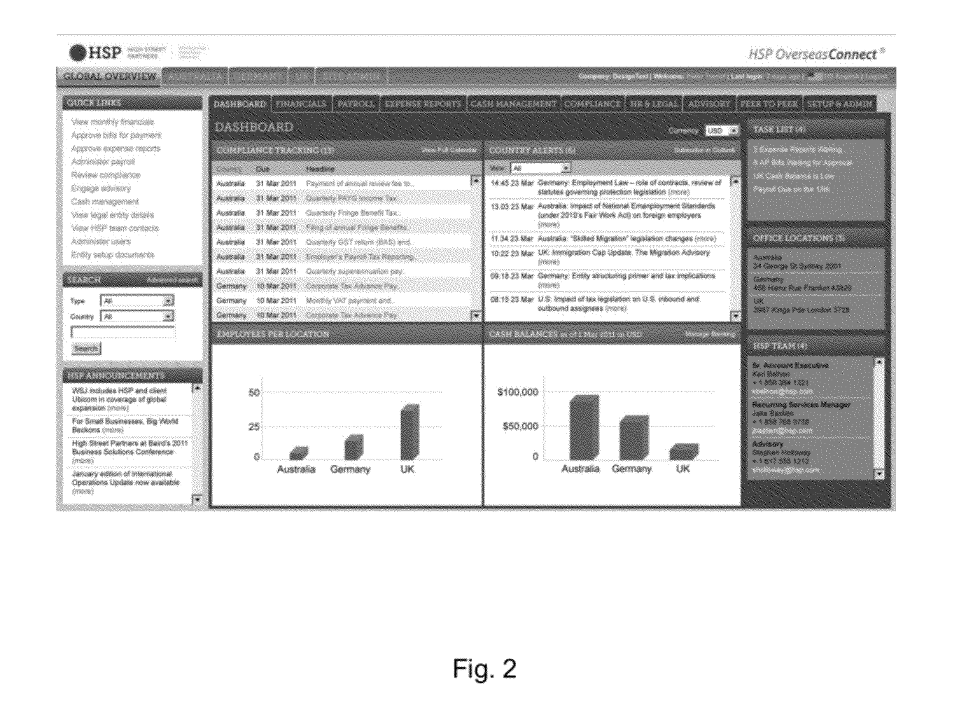

Referring to FIGS. 1 and 2, the international management system presents a customer with a “Global Overview” interface that aggregates information for each of the countries in which the customer operates. The Global Overview interface includes a task list, a catalog of international office locations and contact information, and an overview of international operations (e.g., a visual representation of the number of employees in each office or the cash balances in each office). The Global Overview interface also includes a summary of compliance tracking notifications (discussed in greater detail below) and a feed of country alerts, which notify the customer of important information such as changes in relevant laws. The Global Overview interface also includes tabs for accessing integrated applications related to domains such as accounting, financial reporting, payroll, expense reporting, cash management, compliance tracking, human resources management, legal advisory services, and peer-to-peer social networking These domains will be discussed in greater detail below.

In addition to the Global Overview interface, a country-specific interface is available for each country in which the customer has an operation. For instance, in the example shown in FIG. 2, the customer operates in Australia, Germany, and the UK. Country-specific interfaces include tabs for accessing country-specific sets of integrated applications, including accounting, financial reporting, payroll, expense reporting, cash management, compliance tracking, human resources management, legal advisory services, and peer-to-peer social networking In addition, country-specific details such as the name of the business director in the country and the business license number in the country are available.

The applications provided with each domain may vary depending on the needs of the customer and the requirements of the countries of operation. For instance, a monthly accounting package is generally provided in each country of operation. A payroll processing application includes a list of employees with a tracking of each employee's commission and bonus. The payroll processing application performs gross-to-net calculations to pay employees properly and stores payroll reports. Employee expense reporting can be handling through the interface, allowing for rapid approval and reimbursement of expenses. Human resources and legal functions can also be performed through the interface.

Advisory services are also available through the international management system. An Advisory application provides assistance with country-specific matters such as employment contracts, contractor contracts, and the legal requirements for terminating an employee. In some cases, these advisory services are included with the customer's subscription to the international management system; in other cases, the customer pays a la carte for the use of advisory services. Depending on the expertise of the customer service team of the international management system, the customer service team may function in a legal capacity for the customer (e.g., if a member of the customer service team is able to practice employment law in a particular country), or the customer service team may engage local legal counsel.

More informal advisory services are available through peer-to-peer (social networking) applications. These applications allow customers to contact each other for informal advice. For instance, a customer thinking of expanding into India can reach out to other customers of the international management system for advice about how to best proceed.

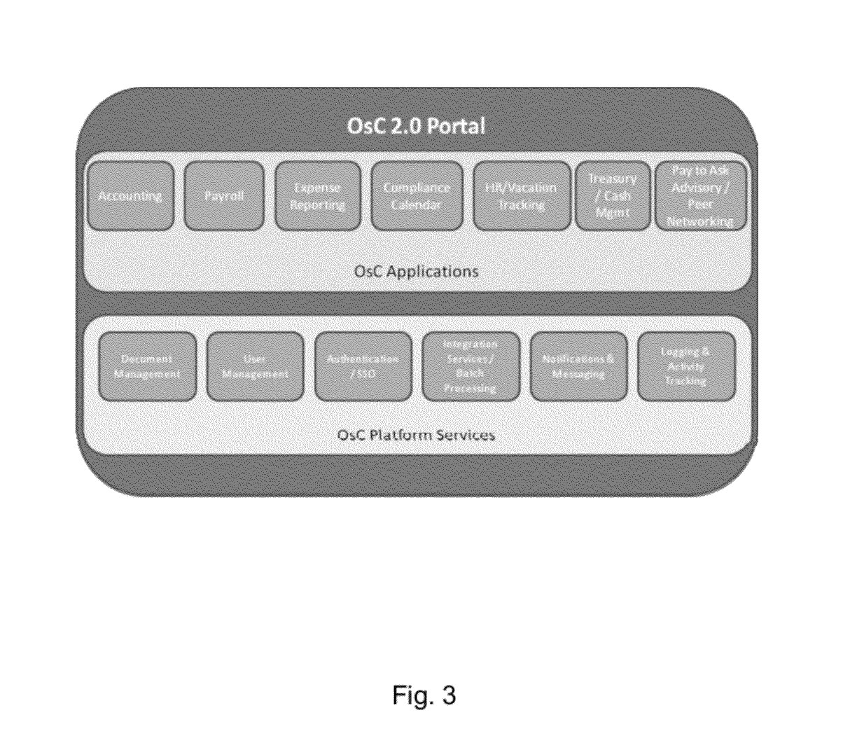

FIG. 3 shows the architecture of the international management system. The applications in the system interact with a shared platform services layer, which provides common functions such as document management, user management, authentication, notification and messaging, document management, and activity tracking This architecture allows a user to access multiple international administrative functions using a single login with a consistent user experience across domains and across countries.

Users of the system (e.g., an accounting professional) may create other users. Users can have unlimited access or restricted access to the system. For instance, a user may be restricted to single domains, such as payroll, across all countries; restricted to certain countries; or restricted to a certain combination of domains and countries. Customer documents, such as payroll documents, financial documents, and compliance documents, are stored in association with the relevant domain, and access to those documents is restricted consistent with access to the corresponding domain.

### 2 Compliance Calendar

A compliance tracking application is provided in the international management system to assist in the management of and compliance with local regulations, such as tax filings or business license renewals. Public holidays, payroll holidays, and other relevant dates can also be tracked. The integration of a compliance calendar in the international management system allows a customer to manage the compliance process without hiring numerous local service providers, thus reducing the possibility that an unexpected gap in coverage will result in a missed deadline.

A general compliance calendar for each country is loaded into a database in the international management system. In some cases, a compliance engine in the international management system retrieves compliance tasks and dates, e.g., from government websites. In other cases, a team of compliance officers or a local service provider generates a list of tasks and deadlines or other general advice. For a particular customer, relevant compliance events are selected by an automated process for inclusion on the customer's calendar based on the customer's legal entity type (e.g., branch office, subsidiary) in each country as well as other operational and/or administrative parameters. The customer can add additional events or reminders to the compliance calendar.

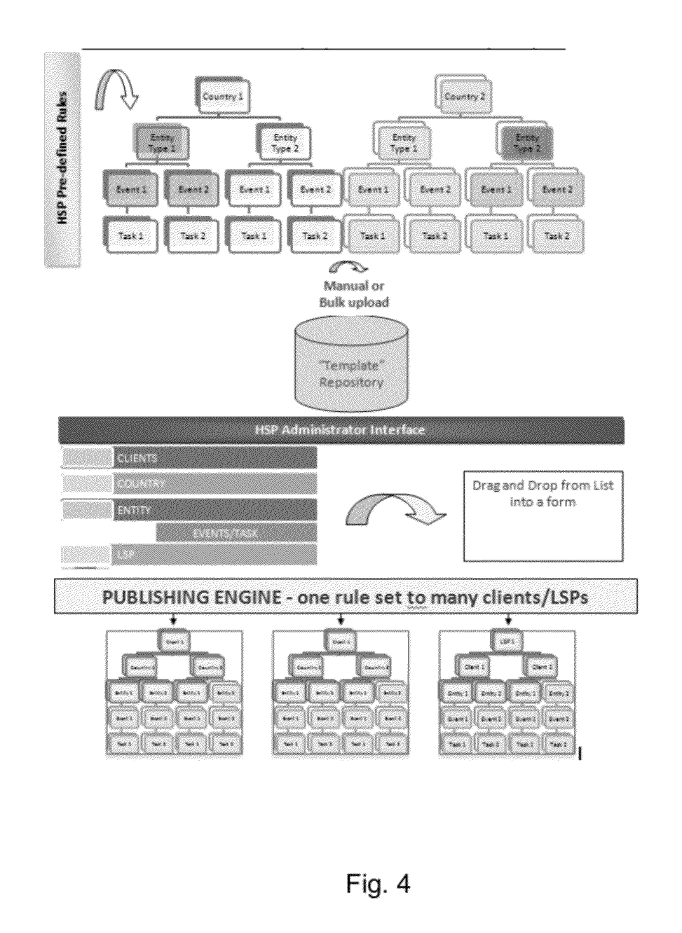

Compliance events are managed as shown in FIG. 4. Within each country, there are various legal entity types, each with different regulatory requirements. For each entity type, there is a set of compliance events to be managed; each event is supported by a set of tasks to be completed. Compliance event dates fall into one of the following categories:
Set date, all customers: An event that applies to all customers and all entity types operating in a given country. The event occurs on the same date for all customers. For instance, the corporate tax filing deadline applies equally to all entities operating in a particular country.
Variable date, all customers: An event that applies to all customers and all entity types operating in a given country. The date of the event is variable based on the customer. For instance, a business license may need to be renewed 12 months from the date on which it was granted; the requirement applies to all entity types but the date varies by customer.
Set date by entity type: An event that applies only to certain legal entity types, but falls on the same date for all customers with that entity type.
Variable date, entity type specific: An event that applies only to certain legal entity types, and is calculated based on an attribute date of the entity.
Customer-specific: A compliance event that applies only to one customer or is a “one-time only” event.

The compliance application of the international management system manages a set of templates for each country and has a publishing engine to publish and adjust the templates to individual customers and customer sites.

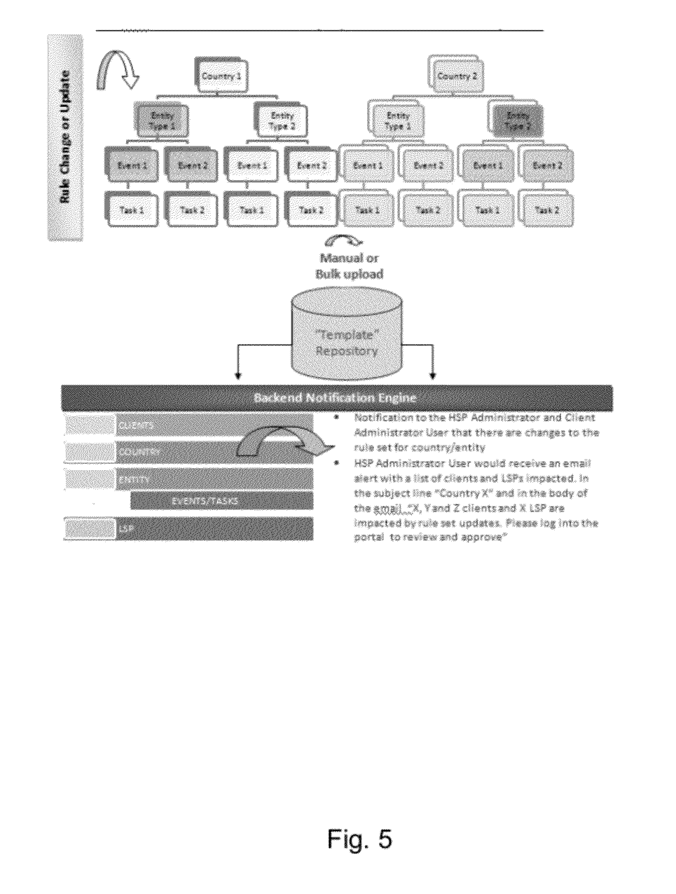

Changes in regulations are applied to all customers using the system shown in FIG. 5. A notification engine detects changes to the rule set for a country or entity and determines the corresponding changes to events and tasks. The changes are populated on the customer's compliance calendar. In addition, the notification engine notifies affected customers that a change has occurred, for instance, via email or via a notification within the international management system user interface.

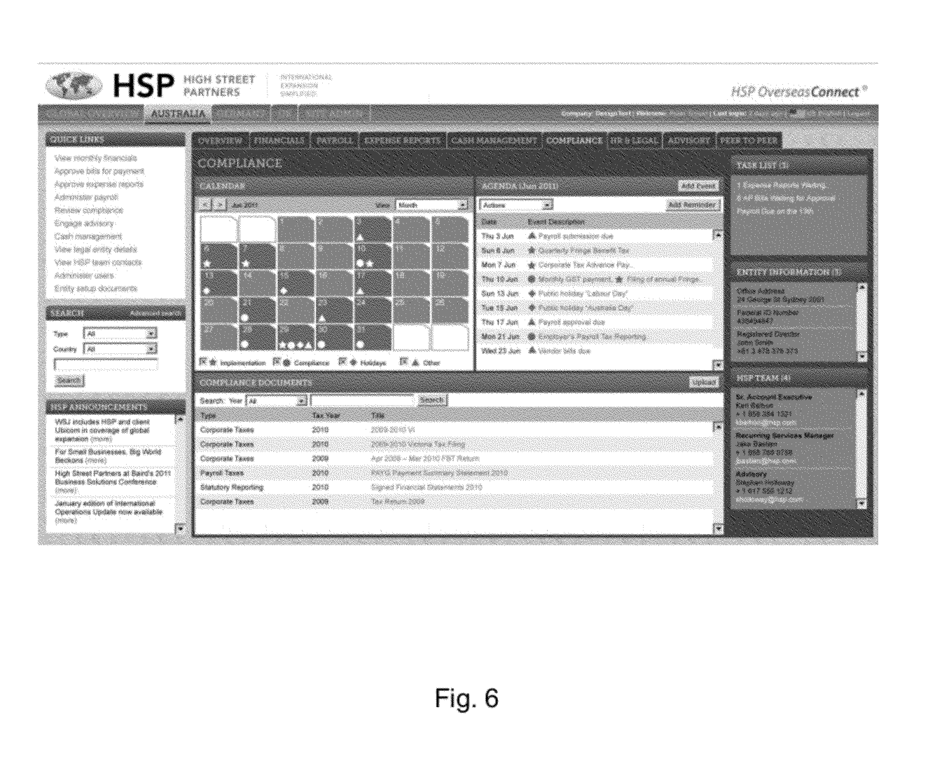

The Compliance user interface is shown in FIG. 6. Events for all countries can be viewed at the “Global Overview” level; country-specific compliance events can be viewed on the single-country interfaces. The compliance interface presents a calendar visually depicting the regulatory filing due dates for the current month or other time period as well as an agenda of detailed events. The customer may configure reminders for specific events to be delivered as email, text message, or automated phone call. The customer can also add events to the calendar as needed. Once events are completed, they are no longer displayed on the calendar. Customers can upload their own filed documents for storage; any documents that the international management system has prepared and filed on the customer's behalf will also be stored in the compliance application.

### 3 Implementation

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

What is claimed is:

1. A non-transitory computer-readable medium that stores executable instructions for causing a processor to:
visually render on a display device a user interface to an application operable to manage a collection of data associated with a plurality of business management functions of a multi-national entity, the user interface including a set of presentation objects, at least some of the presentation objects being operable to control a presentation of information within the user interface; and
responsive to input selecting a first presentation object of the set, visually render in a first region of the user interface, a first view of a subset of the collection of data associated with a first of the plurality of business management functions.

2. The computer-readable medium of claim 1, further comprising instructions for causing the processor to:
responsive to user input selecting a second presentation object of the set, visually render in the first region of the user interface, a second view of the subset of the collection of data associated with the first of the plurality of business management functions.

3. The computer-readable medium of claim 1, further comprising instructions for causing the processor to:
responsive to user input selecting a third presentation object of the set, visually render in a second region of the user interface, a first view of the subset of the collection of data associated with a second of the plurality of business management functions.

4. The computer-readable medium of claim 1, wherein the business management functions includes at least one of accounting, financial reporting, payroll, expense reporting, cash management, compliance tracking, human resources management, and legal advisory services.

5. The computer-readable medium of claim 1, wherein the user interface includes a region associated with social networking

6. A non-transitory computer-readable medium that stores executable instructions for causing a processor to:
identify compliance events applicable to a multi-national entity from a compliance event database based on an attribute of the multi-national entity;
visually render on a display device a user interface to an application operable to manage the compliance events, the user interface including a representation of at least one of the identified compliance events;
responsive to input associated with a first compliance event of the identified compliance events, perform an action on the first compliance event.

7. The computer-readable medium of claim 6, wherein the action includes at least one of modifying the first compliance event, deleting the first compliance event, or performing an action associated with fulfilling the compliance event.

8. The computer-readable medium of claim 6, wherein the user interface is further a user interface to an application operable to manage a collection of data associated with a plurality of business management functions of the multi-national entity.

9. The computer-readable medium of claim 6, further comprising instructions for causing the processor to:
provide, to a user, a notification of at least one of the identified compliance events.
